(19) United States
(12) Patent Application Publication
(10) Pub. No.: US 2011/0065541 A1
(43) Pub. Date: Mar. 17, 2011

(54) SPROCKET ASSEMBLY

(76) Inventor: Sen-Piao Lai, Wufeng Township (TW)

(21) Appl. No.: 12/581,067

(22) Filed: Oct. 16, 2009

(30) Foreign Application Priority Data
Sep. 11, 2009 (TW) 098216849

(51) Int. Cl. F16H 55/30; B62M 9/10

(52) U.S. Cl. 474/160

(57) ABSTRACT

A sprocket assembly of the present invention includes a first sprocket and a bigger second sprocket. The first sprocket has a small-diametered tooth having a beveled edge. The beveled edge is tapered from a first face to a second face along a transmission direction. The second sprocket has a big-diametered tooth, which is clockwise adjacent to the small-diametered tooth having the beveled edge, having a thinner section. The thinner section is stepped at an outer face of the second sprocket. A chain of a bicycle selectively surrounds the first sprocket or the second sprocket, and a travel path thereof shifts quickly and easily via the beveled edge and the thinner section.

### BACKGROUND OF THE INVENTION

1. Field of the Invention

The present invention relates to a sprocket assembly of human-powered vehicle, and more particularly to a multispeed sprocket assembly.

2. Description of the Prior Art

A sprocket assembly is common installed at a center of a bicycle back wheel and has a unidirectional transmission relationship with a hub. Thus, the sprocket assembly is driven by a chain to rotate the hack wheel. A conventional sprocket assembly includes several sprockets, each has different diameter to provide different transmission ratio to achieve the effects of high speed or strength saving.

U.S. Pat. No. 4,889,521 discloses a sprocket assembly having a larger diameter sprocket and a smaller diameter sprocket. The lager diameter sprocket has a chain guide portion disposed at an inner surface thereof. More specifically, the chain guide portion is formed of a cutout that overlaps at least a tooth of the smaller diameter sprocket for the chain to easily shift from the smaller diameter sprocket to the larger diameter sprocket.

### SUMMARY OF THE INVENTION

The main object of the present invention is to provide a sprocket assembly allowing the chain to shill easily.

To achieve the above object, a sprocket assembly of the present invention includes a first sprocket and a bigger second sprocket. The first sprocket has a first face and a second face opposite to the first face. The sprockets are co-axially and parallel disposed. A plurality of small-diametered teeth are spaced and radially extended from a periphery of the first sprocket, and a plurality of large-diametered teeth are spaced and radially extended form a periphery of the second sprocket. At least one of the small-diametered teeth has a beveled edge, which is tapered from a first face to a second face along a transmission direction. At least one of the larger-diametered teeth has a thinner section clockwise adjacent to the small-diametered tooth having the beveled edge. The thinner section is stepped at an outer face of the second sprocket.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a front view of a sprocket assembly having several sprockets of the present invention;

FIG. 2 is a front view of a sprocket assembly of the present invention;

FIG. 3 is a partial pictorial drawing showing first sprocket of a sprocket showing assembly of the present invention;

FIG. 4 is a rear view of a sprocket assembly of the present invention;

FIG. 5 is a partial pictorial drawing showing a second sprocket of a sprocket assembly of the present invention;

FIG. 6 is a front view of a sprocket assembly showing the relative position of a first tooth and a second tooth of the present invention;

FIG. 7 is a partial front view showing a chain shifting from a first sprocket to a second sprocket;

FIG. 8 is a partial front view showing a chain shifting from a second sprocket to a first sprocket.

### DETAILED DESCRIPTION OF THE PREFERRED EMBODIMENTS

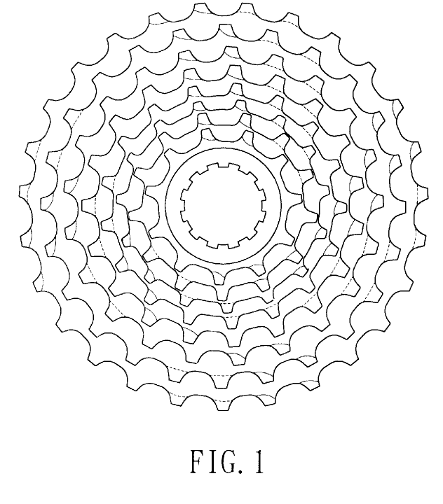

Please refer to FIG. 1. The present invention provides a sprocket assembly for a human-powered vehicle. The sprocket assembly has several sprockets assembled together or integrally formed, and it is installed in a transmission system of the human-powered vehicle and is driven by a chain, which can shift between the sprockets to vary the transmission ratio.

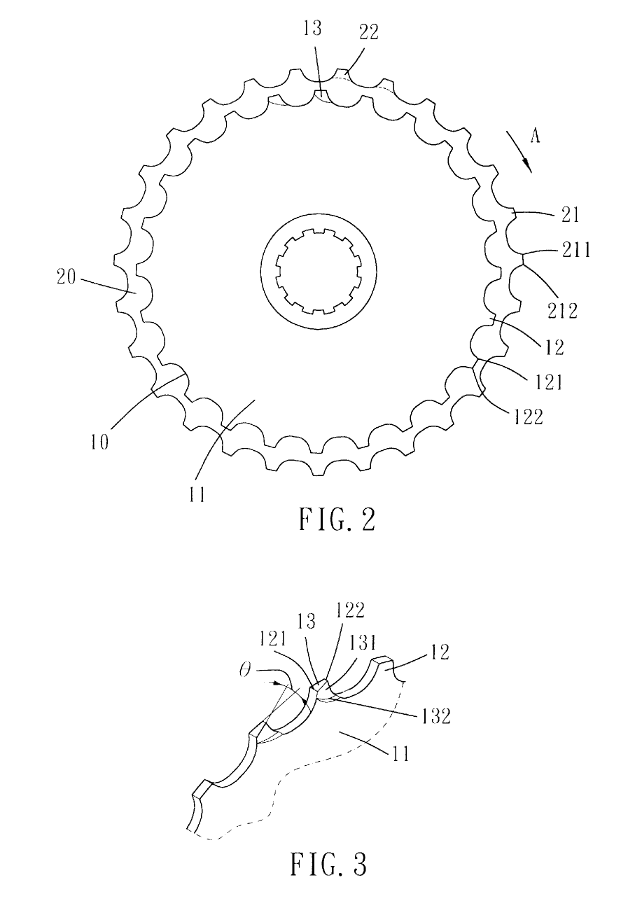

Please refer to FIG. 2. The present embodiment merely shows two sprockets to interpret the features of the present invention. Note that such features disclosed hereinafter can be applied on any two adjacent sprockets of the sprocket assembly as shown in FIG. 1. The sprocket assembly includes a circular first sprocket 10 and a second sprocket 20. The first sprocket has a first face 11 and a second face opposite to the first face. A clockwise rotational direction of the first face 11 is defined as a transmission direction A. A plurality of small-diametered teeth 12 is spaced and radially extended front a periphery of the first sprocket 10. Each small-diametered tooth 12 has a first corner 121 and a second corner 122 sequentially formed on a distal end thereof along the transmission direction A. At least one of the small-diametered teeth 12 is defined as a first tooth 13, and the first tooth 13 has a beveled edge 131.

As shown in FIG. 3, the beveled edge 131 is tapered from the first face 11 to the second face along the transmission direction A, and the beveled edge 131 makes an angle O of 5-15 degrees to the second face. In addition, a curve surface 132 is formed between the beveled edge 131 and the first face 11. The curve surface 132 is perpendicular to the first face 11 and concave toward a center of the first sprocket 10. The curve surface 132 has a first end close to the first corner 121 and a second end away from the first corner 121. The second end of the curve surface 132 is closer to the center of the first sprocket 10 than the first end is. Thus the curve surface 132 generally faces the second corner 122 of the first tooth 13.

Refer to FIG. 2 again. The second sprocket 20 is co-axial with and parallel to the first sprocket 10, and it is spaced disposed near the second face. A diameter of the second sprocket 20 is bigger than that of the first sprocket 10. A plurality of big-diametered teeth 21 are spaced and radially extended from a periphery of the second sprocket 20. Each big-diametered tooth 21 has a first corner 211 and a second corner 212 sequentially disposed on a distal end thereof along the transmission direction A. At least one of the big-diametered teeth is defined as a second tooth 22, and the second tooth 22 has a thinner section.

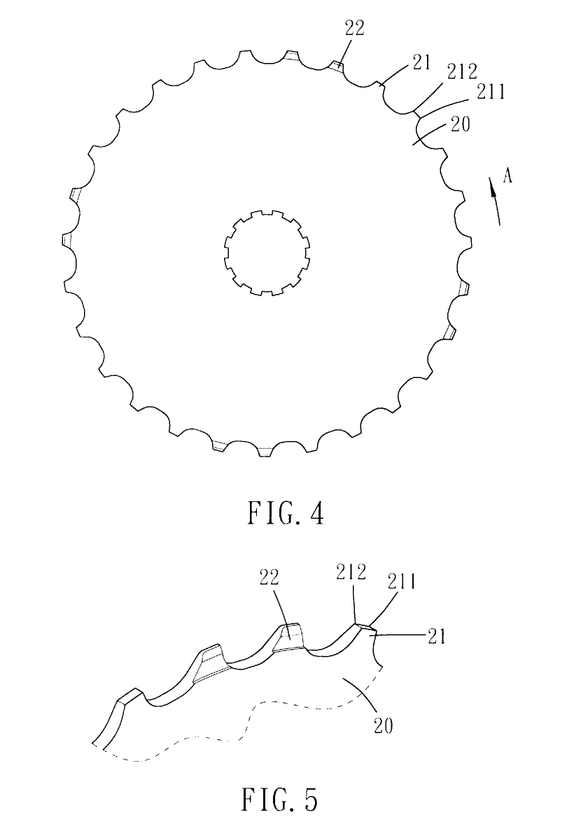

As shown in FIGS. 4 and 5, the thinner section is stepped at an outer face of the second sprocket 20, such that it has a thickness smaller than the second sprocket 20. The outer face of the second sprocket 20 faces opposite to the first sprocket 10. Specifically, the second tooth 22 is cut from the outer face to form the stepped thinner section.

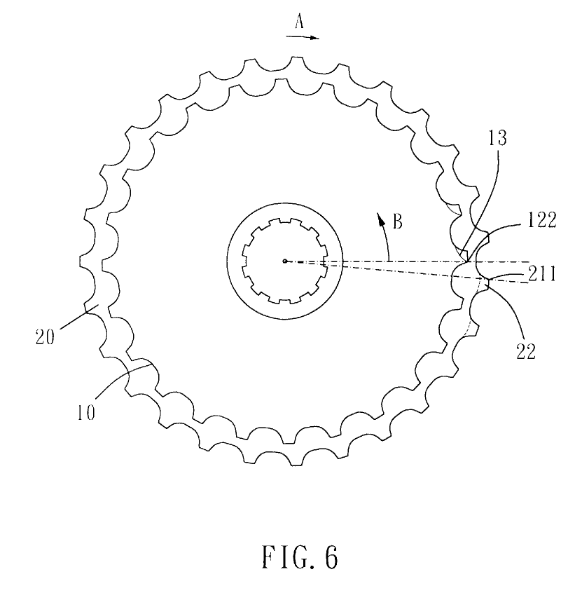

Please refer to FIG. 2 again. The first tooth 13 and the second tooth 22 are adjacent to each other to make a shifting guide set. To more specifically indicate the relative position of the first and second teeth 13 and 22, please refer to FIG. 6. A polar coordinate system is defined on the first face 11 of the first sprocket 10. The center of the first sprocket 10 is defined as a pole of the polar coordinate system, and a ray defined from the pole and passing through the second corner 122 of the first tooth 13 is a polar axis of the polar coordinate system. A positive polar angle is measured from the polar axis along the counterclockwise direction B. As such, the second corner 122 or the first tooth 13 has a polar angle of 0 degree. The first corners 211 of the big-diametered teeth 21 have projection points on the polar coordinate system. The projection point of the second tooth 22 has a polar angle being the most close to but not exceeding 360 degrees among all the projection points. As such, the first and second teeth 13 and 22 are adjacent to each other with desired interval.

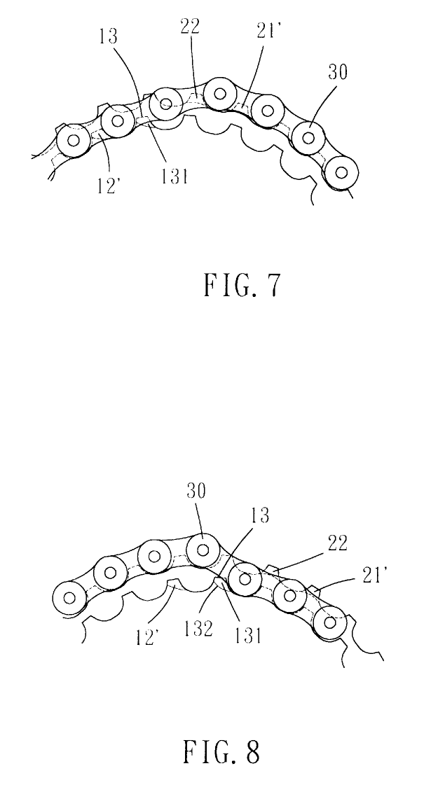

Please refer to FIG. 7. When the chain 30 is shifting from the second sprocket 20 to the first sprocket 10, the chain 30 is inclined from the second tooth 22 to approach the first sprocket 10, and the first tooth 13 has a beveled edge 131 for the chain 30 to easily and smoothly engage therewith. To further smooth the shifting movement, the big-diametered tooth 21′ clockwise adjacent to the second tooth 22 may also have a thinner section, and the small-diametered tooth 12′ counterclockwise adjacent to the first tooth 13 may have a beveled edge as well.

Refer to FIG. 8. When the chain 30 is shifting from the first sprocket 10 to the second sprocket 20, the chain 30 is inclined from the beveled edge 131 of the first tooth 13 to approach and thereafter engage with the second sprocket 20.

The sprocket assembly of the present invention may have multiple shilling guide sets. Each two adjacent shifting guide sets are separated by one to seven small-diametered teeth 12. Preferably, two to five shifting guide sets may be provide on two adjacent sprockets.

In summarization, the sprocket assembly of the present invention has shilling guide set(s) to smooth the shilling movement of the chain. Although the beveled edge is tapered, the first tooth still has a thicker surface, which provides sufficient mechanical strength, near the first corner for the chain to transmit driving force thereto. The sprocket assembly of the present invention may be provided with the chain guide portion as disclosed in U.S. Pat. No. 4,889,521 to further enhance the shilling efficiency.

What is claimed is:

1. A sprocket assembly, comprising:
a first sprocket, having a first nice and a second face opposite to the first face, a clockwise rotational direction of the first face being defined as a transmission direction, a plurality of small-diametered teeth being spaced and radially extended from a periphery of the first sprocket, each small-diametered tooth having a first corner and a second corner sequentially formed on a distal end thereof along the transmission direction;
a second sprocket, having a bigger diameter than the first sprocket, the second sprocket being co-axial with and parallel to the first sprocket, the second sprocket being spaced disposed near the second face, a plurality of big-diametered teeth being spaced and radially extended from a periphery of the second sprocket, each big-diametered tooth haying a first corner and a second corner sequentially disposed on a distal end thereof along the transmission direction;
at least one shifting guide set, each of which comprises a first tooth and a second tooth, the first tooth being one of the small-diametered teeth, a polar coordinate system being defined on the first face of the first sprocket, a center of the first sprocket being defined as a pole of the polar coordinate system, a ray defined from the pole and passing through the second corner of the first tooth being a polar axis of the polar coordinate system, the second tooth being one of the big-diametered teeth, the first corners of the big-diametered teeth having projection points on the polar coordinate system, and the projection point of the second tooth having a polar angle, which is measured counterclockwise from the polar axis, being the most close to but not exceeding 360 degrees among all the projection points;
wherein the first tooth has a beveled edge, the beveled edge is tapered from the first face to the second face along the transmission direction, the second tooth has a thinner edge which is stepped at an outer face of the second sprocket, the outer face of the second sprocket faces opposite to the first sprocket.

2. The sprocket assembly of claim 1, wherein the beveled edge makes an angle of 5-15 degrees to the second face.

3. The sprocket assembly of claim 1, wherein a curve surface is formed between the beveled edge and the first face, the curve surface is perpendicular to the first face and concave toward the center of the first sprocket, the curve surface has a first end close to the first corner and a second end away from the first corner, the second end of the curve surface is closer to the center of the first sprocket than the first end is.

4. The sprocket assembly of claim 1, wherein the small-diametered tooth counterclockwise adjacent to the first tooth has a beveled edge.

5. The sprocket assembly of claim 4, wherein the big-diametered tooth clockwise adjacent to the second tooth has a thinner section.

6. The sprocket assembly of claim 5, comprising multiple shifting guide sets, each two adjacent shifting guide sets are separated by one to seven small-diametered teeth.

7. The sprocket assembly of claim 1, wherein the first sprocket and the second sprocket are integrally formed.
